(19) United States
(12) Patent Application Publication
(10) Pub. No.: US 2018/0365175 A1
(43) Pub. Date: Dec. 20, 2018

(54) SYSTEMS AND METHODS TO TRANSMIT I/O BETWEEN DEVICES BASED ON VOICE INPUT

(71) Applicant: Lenovo (Singapore) Pte. Ltd., New Tech Park (SG)

(72) Inventors: John Weldon Nicholson, Cary, NC (US); Daryl Cromer, Cary, NC (US); David Alexander Schwarz, Morrisville, NC (US); Scott Patrick Debates, Crystal Lake, IL (US)

(21) Appl. No.: 15/626,908

(22) Filed: Jun. 19, 2017

(51) Int. Cl. G06F 13/12; G06F 3/16

(52) U.S. Cl. CPC G06F 13/126; G06F 3/167

(57) ABSTRACT

In one aspect, a first device includes at least one processor and storage accessible to the at least one processor. The storage bears instructions executable by the at least one processor to facilitate a connection between a second device and a third device, with at least the second device including an input/output (I/O) interface. The instructions are also executable by the at least one processor to receive a voice command from a user to transmit I/O between the second device and the third device and, responsive to receipt of the voice command, transmit I/O between the second device and the third device. The I/O is at least one of input using the I/O interface and output using the I/O interface.

### BACKGROUND

As recognized herein, digital assistants are becoming more commonplace in today's technological environments. However, as also recognized herein, many digital assistants operate using stand-alone devices that do not have input/output (I/O) capability beyond a microphone and speaker for interaction with a user. The present application recognizes that this unnecessarily limits the capability of the digital assistant itself. There are currently no adequate solutions to the foregoing computer-related, technological problem.

### SUMMARY

Accordingly, in one aspect a first device includes at least one processor and storage accessible to the at least one processor. The storage bears instructions executable by the at least one processor to facilitate a connection between a second device and a third device, with at least the second device including an input/output (I/O) interface. The instructions are also executable by the at least one processor to receive a voice command from a user to transmit I/O between the second device and the third device and, responsive to receipt of the voice command, transmit I/O between the second device and the third device. The I/O is at least one of input using the I/O interface and output using the I/O interface.

In another aspect, a method includes identifying a context associated with at least one of the first device and the second device, with the first device including an input/output (I/O) interface. The method also includes suggesting, based on the context, that I/O be performed at one of the first device and the second device using communication with the other of the first device and the second device. Still further, the method includes receiving voice input accepting the suggestion and transmitting, responsive to receipt of the voice input, I/O between the first device and the second device. The I/O is at least one of input using the I/O interface and output using the I/O interface.

In still another aspect, a computer readable storage medium (CRSM) that is not a transitory signal includes instructions executable by at least one processor to process, using a digital assistant, a command to transmit I/O between a first device and a second device. The instructions are also executable by the at least one processor to transmit I/O between the first device and the second device responsive to receipt of the command, with the I/O at least one of being input using an I/O interface on the first device and being output using an I/O interface on the second device.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is a block diagram of an example network of devices in accordance with present principles;

FIGS. 3-6 are example illustrations in accordance with present principles;

FIGS. 7 and 9 are example user interfaces (UIs) in accordance with present principles; and

FIG. 8 is a flow chart of an example algorithm in accordance with present principles.

### DETAILED DESCRIPTION

Disclosed herein are systems and methods for connecting one or more aspects of the I/O of one device to the processing and/or I/O of another device. For example, a user may speak his or her desired routing of I/O, such as “Send this keyboard to that device”.

Additionally, a predictive GUI/software module may be used for suggested routing and/or connections. Suggestions may include crowd-sourced routing suggestions and event pairs based on what other users have done in other environments, template/default suggestions and event pairs that may be set as defaults by a provider based on the provider's research of what users are likely to want, and suggestions and event pairs based on the historical usage by the user and/or the user's device(s). Thus, connections may be suggested to a user given a specific event or context, and the user may accept the suggestion in just one click, tap, nod, “yes” voice input, and/or other acknowledgement or acceptance.

Additionally, a predictive connection list may be used to improve recognition if the user speaks a desired I/O outcome without specifying specific devices for I/O routing. For example, recognition/determination of an appropriate connection of I/O devices may be biased towards making a most-likely-to-be-used connection as predicted based on a priority set forth in the list.

Still further, in some examples security and authentication requirements may be used for user commands of desired I/O routing. Authentication may be done biometrically, such as through voice recognition using the voice command itself, or other techniques.

With respect to any computer systems discussed herein, a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple, Google, or Microsoft. A Unix or similar such as Linux operating system may be used. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any conventional general purpose single- or multi-chip processor that can execute logic by means of various lines such as address lines, data lines, and control lines and registers and shift registers. Moreover, any logical blocks, modules, and circuits described herein can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/or made available in a shareable library.

Logic when implemented in software, can be written in an appropriate language such as but not limited to C# or C++, and can be stored on or transmitted through a computer-readable storage medium (that is not a transitory, propagating signal per se) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

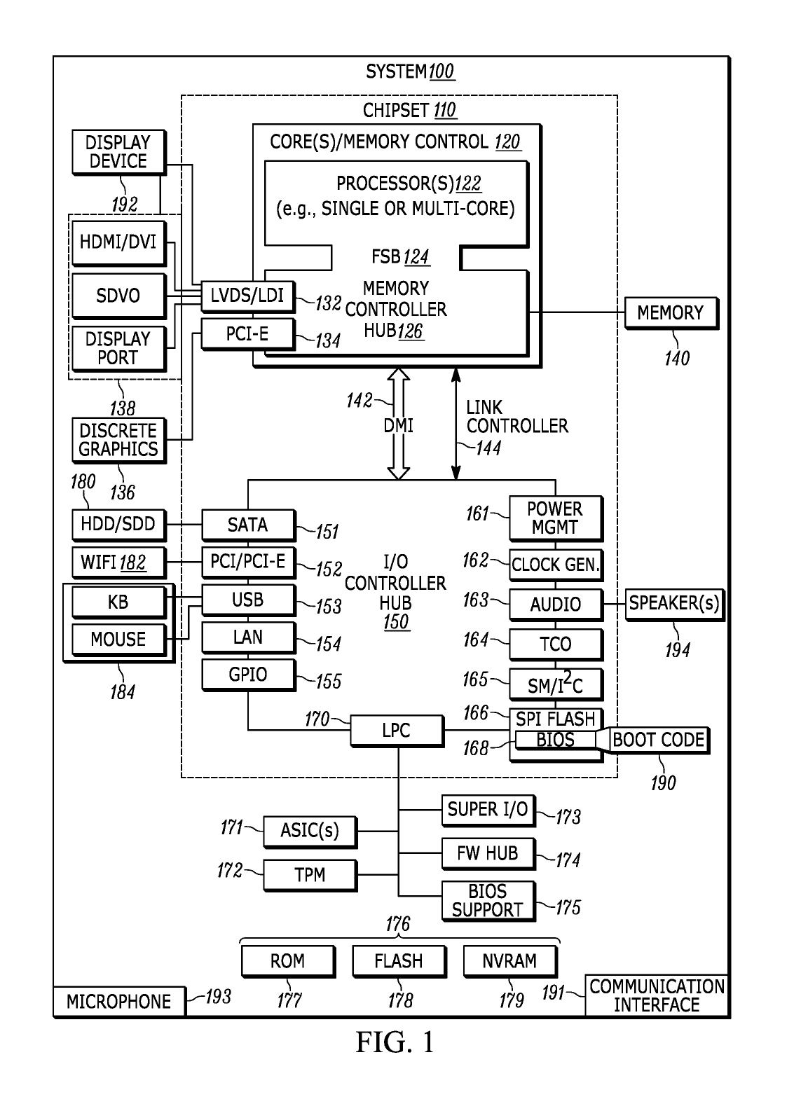

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be, e.g., a game console such as XBOX®, and/or the system 100 may include a wireless telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the conventional “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 may provide for communication with various devices, networks, etc. For example, where used, the SATA interface 151 provides for reading, writing or reading and writing information on one or more drives 180 such as HDDs, SDDs or a combination thereof, but in any case the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

The system 100 may also include one or more communication interfaces 191 for communication with other devices, including communication with a stand-alone digital assistant device and communication with other devices having input/output (I/O) capability as disclosed herein. The communication interface(s) 191 may be for one or more of Bluetooth or Bluetooth low energy communication, near-field communication protocol (NFC), universal serial bus (USB)/bus line communication (e.g., wired or wireless), local area network communication (e.g., Internet of things communication), wide area network (WAN) communication, and Wi-Fi/Wi-Fi direct communication specifically.

Further, the system 100 may include an audio receiver/microphone 193 that provides input to the processor(s) 122 based on audio that is detected, such as via a user providing audible voice input to the microphone 193 in accordance with present principles.

Additionally, though not shown for clarity, in some embodiments the system 100 may include a gyroscope that senses and/or measures the orientation of the system 100 and provides input related thereto to the processor 122, as well as an accelerometer that senses acceleration and/or movement of the system 100 and provides input related thereto to the processor 122. Still further, the system may include a camera that gathers one or more images and provides input related thereto to the processor 122. The camera may be a thermal imaging camera, a digital camera such as a webcam, a three-dimensional (3D) camera, and/or a camera otherwise integrated into the system 100 and controllable by the processor 122 to gather pictures/images and/or video. Also, the system 100 may include a GPS transceiver that is configured to receive geographic position information from at least one satellite and provide the information to the processor 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

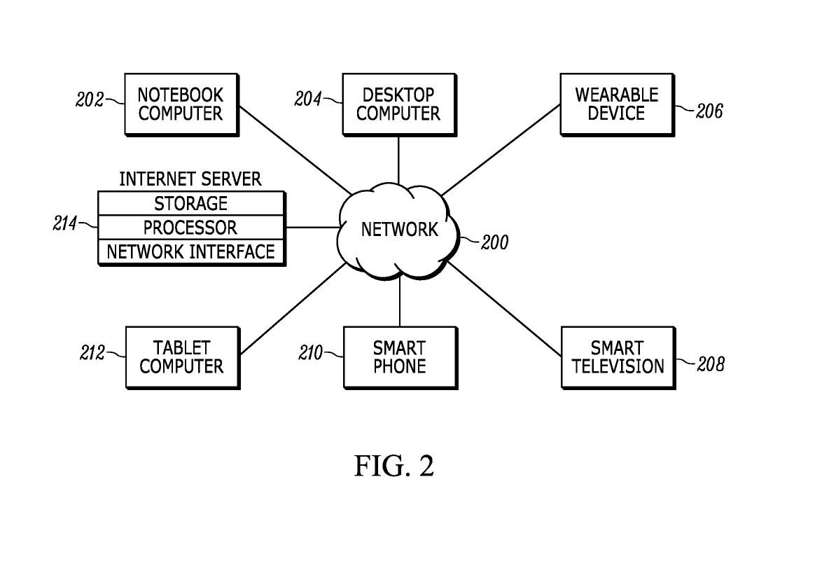

Turning now to FIG. 2, example devices are shown communicating over a network 200 such as the Internet in accordance with present principles. It is to be understood that each of the devices described in reference to FIG. 2 may include at least some of the features, components, and/or elements of the system 100 described above. Indeed, any of the devices disclosed herein may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, and a server 214 such as an Internet server that may provide cloud storage accessible to the devices 202-212. It is to be understood that the devices 202-214 are configured to communicate with each other over the network 200 to undertake present principles. It is to also be understood that any of the devices 202-212 and even the server 214 may include one or more of the input/output (I/O) interfaces such as touch-enabled displays, keyboards, mice or other cursor-movement devices, printers, speakers, etc.

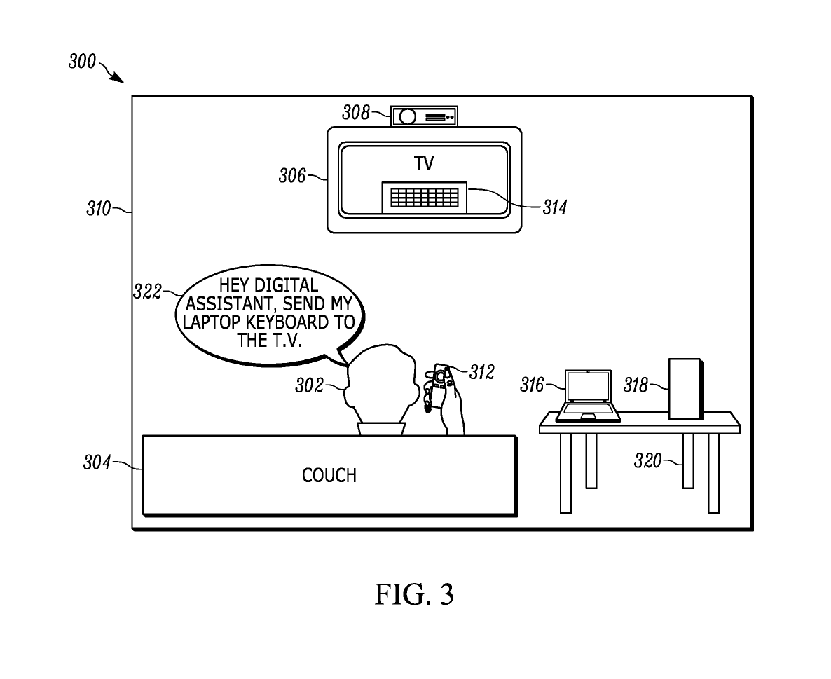

Now describing FIG. 3, it shows an example illustration 300 of present principles. A user 302 is shown sitting on a couch 304 and watching audio video content presented on a television (TV) 306. Note that the TV 306 has a camera 308 that may be controllable by any of the devices within the environment 310 in which the user is disposed and with which the TV 306 communicates. In this case, the environment 310 is the living room of a personal residence. The camera 308 may be controllable to gather one or more images of the user 302 to authenticate the user via facial recognition to thus determine that the user 302 is authorized to provide verbal and other commands, as will be described further below.

As also shown in FIG. 3, the user 302 is holding a remote control 312 for the TV 306 in order to manipulate a cursor presented as part of a keyboard 314 on the TV 306. A laptop computer 316 is shown on a table 320 within the environment, along with a stand-alone digital assistant device 318 that executes a digital/personal assistant application (e.g., in conjunction with a remotely-located server for further processing) and facilitates communication between other devices within the environment 310. In some embodiments, the device 318 may be a Lenovo Smart Assistant sold by Lenovo (US) Inc. of Morrisville, N.C. and may execute a digital assistant application that may be generally similar to Amazon's Alexa or Apple's Siri, for instance. The digital assistant application may be executed by a processor in the device 318 to execute tasks and functions as described herein.

It is to be understood that in the illustration 300, the user 302 is becoming frustrated with the amount of time it is taking him/her to use the remote control 312 to manipulate the cursor to provide keyboard input to the TV 306 via the keyboard 314. Because of this, the user 302 provides a response cue (“Hey digital assistant”) and verbal command 322 to the device 318 indicating that input from the keyboard of the laptop 316 should be sent to the TV 306 since providing input using the keyboard of the laptop 316 will be less time-consuming for the user 302 than using the keyboard 314.

In turn, a microphone on the device 318 may recognize the response cue when provided and know to process the ensuing command, subject in some embodiments to authentication (e.g., using voice and/or facial recognition) that the user 302 is authorized to provide such a command. The user 302 may then use the keyboard on the laptop 316 to provide input that the device 318, based on receipt of the cue/command 322, knows to transmit wirelessly (e.g., using Wi-Fi) to the TV 306. The TV 306 may then process the input from the keyboard of the laptop 316 as if the input were provided via the keyboard 314 instead, and in some embodiments the device 318 may even facilitate processing by the TV 306 of the input to the keyboard of the laptop 316 such as if the format of the input may need to be converted for the TV 306 to process the input.

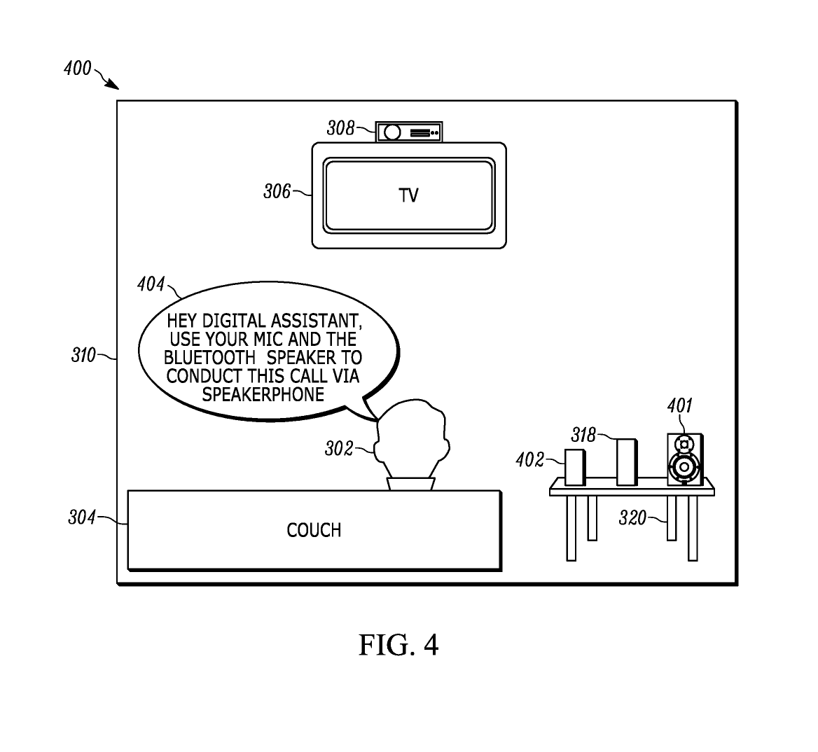

Moving on to FIG. 4, another illustration 400 is shown. The user 302 is again shown sitting on the couch 304 within the environment 310 while watching audio video content presented on the TV 306. A Bluetooth-enabled speaker 401 and a smart phone 402 are now disposed on the table 320. It is to be understood that the smart phone 402 is receiving an incoming telephone call and that the user 302 is aware of the incoming call. So that the user 302 does not have to move from his/her current position on the couch 304 to get the phone 402 to answer the incoming telephone call, the user provides a response cue and verbal command 404 to the device 318. The cue/command 404 indicates that the device 318 should coordinate with the phone 402 to use a speakerphone-type of input/output so that the user may engage in the telephone call without moving from his/her current position by providing verbal input as detected by the microphone on the device 318 and by listening to audio output via the speaker 401 as may be transmitted by the phone 402. Again, in some embodiments the user 302 may be authenticated before the command 404 is complied with by the device 318.

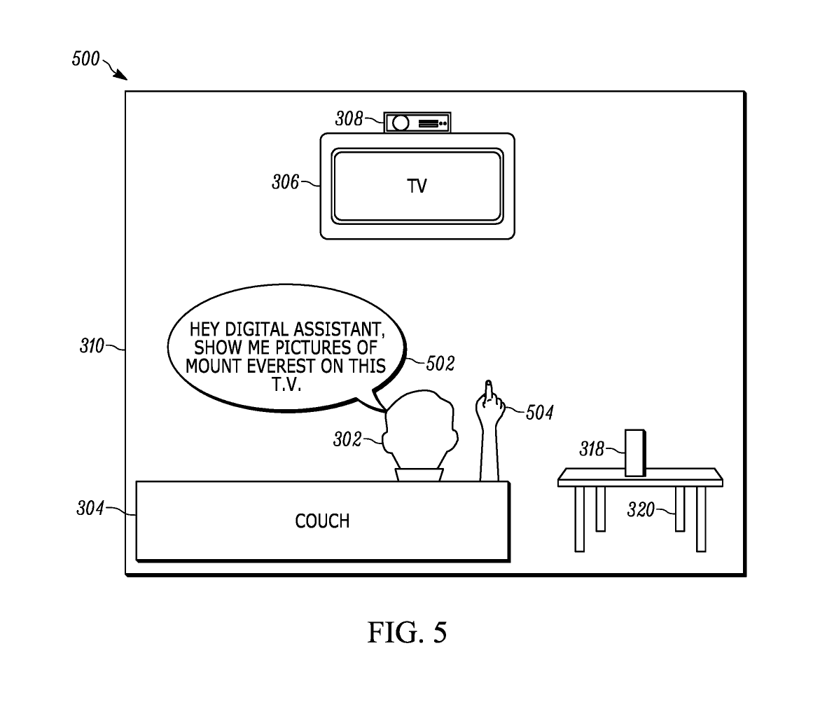

Continuing the detailed description in reference to FIG. 5, yet another illustration 500 is shown. The user 302 is again shown sitting on the couch 304 within the environment 310 while in front of the TV 306. Also, the digital assistant device 318 is again shown on the table 320. In this example, the user provides a response cue and verbal command 502 to the device 318 indicating that the device 318 should present images of Mount Everest on “this TV”, which the device 318 may recognize as the TV 306 based on communication with the TV 306 to receive images from the camera 308 on the TV 306. The images from the camera 308 may be processed using gesture recognition to determine a device to which the user is pointing using his/her finger and arm 504. Thus, based on identification of the TV 306 as the device to which the user is pointing, the device 318 may perform an Internet search for images of Mount Everest and then communicate with the TV 306 to output the images on the TV 306. Here too the user 302 may be authenticated before the command 502 is complied with by the device 318.

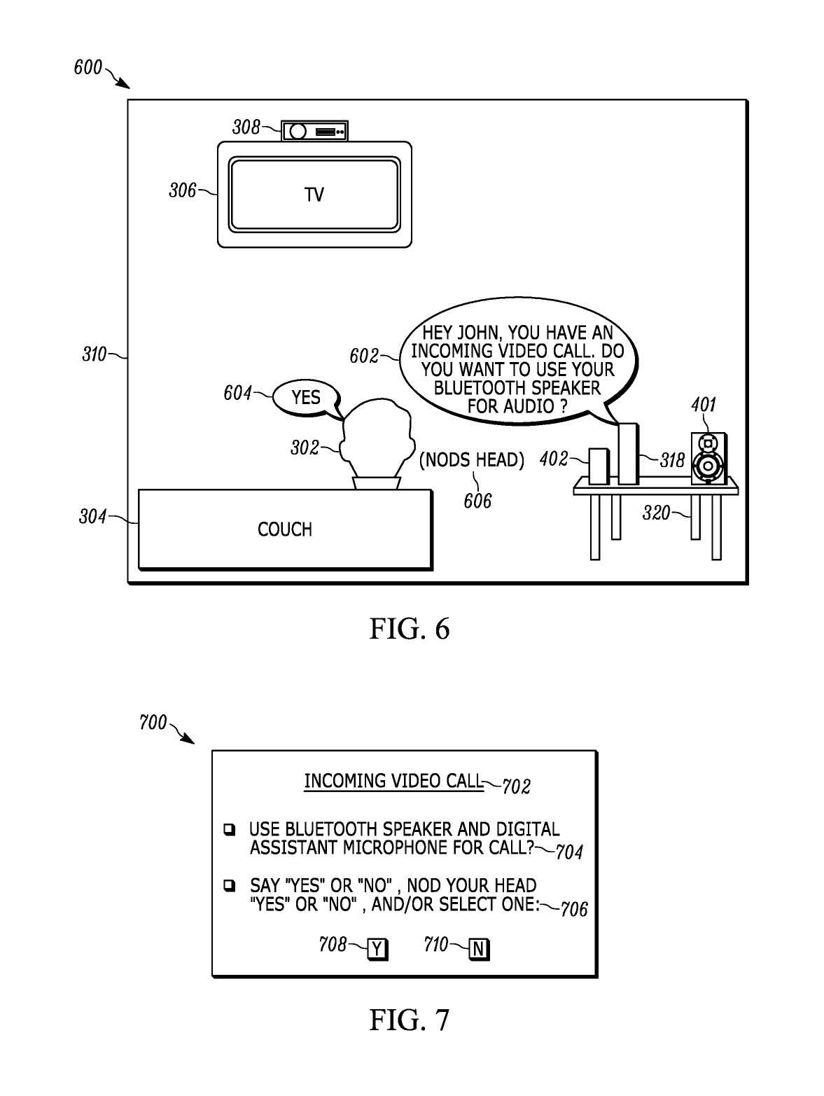

FIG. 6 shows another illustration 600 in accordance with present principles. Note that the Bluetooth speaker 401 and phone 402 are again shown as being disposed on the table 320. Based on communication with the phone 402, the device 318 determines that a video telephone call is incoming to the phone 402. Responsive to that determination and without a request from the user 302, the device 318 may provide audio output 602 using its own speaker (or using the Bluetooth speaker 401).

The audio output 602 indicates the name of the user 302 to get the attention of the user 302, and also indicates that a video telephone call is incoming. The audio output 602 also asks whether the user 302 would like to use the Bluetooth speaker 401 for output of audio of the telephone call. As also shown in the illustration 600, the user 302 provides a verbal response 604 in the affirmative, and also provides a gesture response 606 of an up-down-up head nod in the affirmative (as may be recognized based on execution at the device 318 of gesture recognition software using images of the user 302 from the camera 308).

Responsive to one or both of the responses 604, 606 (and, in some embodiments, responsive to authentication of the user 302), the device 318 answers or otherwise facilitates initiation of the incoming video telephone call. The device 318 then facilitates communication between the phone 402 and camera 308 to transmit images of the user 302 as output by the camera 308 to the device of the person on the other end of the video call. The device 318 also uses its own microphone or one on the phone 402 to receive audio input from the user 302 as he/she speaks to the other person to transmit audio data for the call to the device of the other person. Additionally, the device 318 uses the speaker 401 to output audio from the other person as they speak to the user 302 during the call, and also uses the TV 306 to output images of the other person as received from the other person's device while engaged in the video call.

Now in reference to FIG. 7, it shows an example user interface (UI) 700 that may be presented on a display of a device according to the incoming video call example discussed above in reference to FIG. 6. The UI 700 may be output by the device 318 in addition to or in lieu of the audio output 602. Additionally, it is to be understood that the UI 700 may be output on any suitable display available to the device 318 and/or with which the device 318 otherwise communicates. For example, the UI 700 may be output on the TV 306 and/or display of the smart phone 402.

As shown in FIG. 7, the UI 700 may include an indication 702 of the incoming video call. The UI 700 may also include a prompt 704 asking whether the user 302 would like to use the Bluetooth speaker 401 for output of audio of the video telephone call and the microphone on the device 318 for audio input for the video telephone call. Still further, the UI 700 may include instructions 706 notifying the user 302 that the user 302 may audibly respond in the affirmative or negative, may respond with head-nod gestures in the affirmative or negative, and/or may respond in the affirmative or negative by respectively selecting the yes selector 708 or no selector 710 presented on the UI 700. The selectors may be selected by the user by manipulating a cursor to select one of them, by providing touch input to an area of a touch-enabled display that presents them, by providing eye input selecting them, by providing verbal input selecting them, etc.

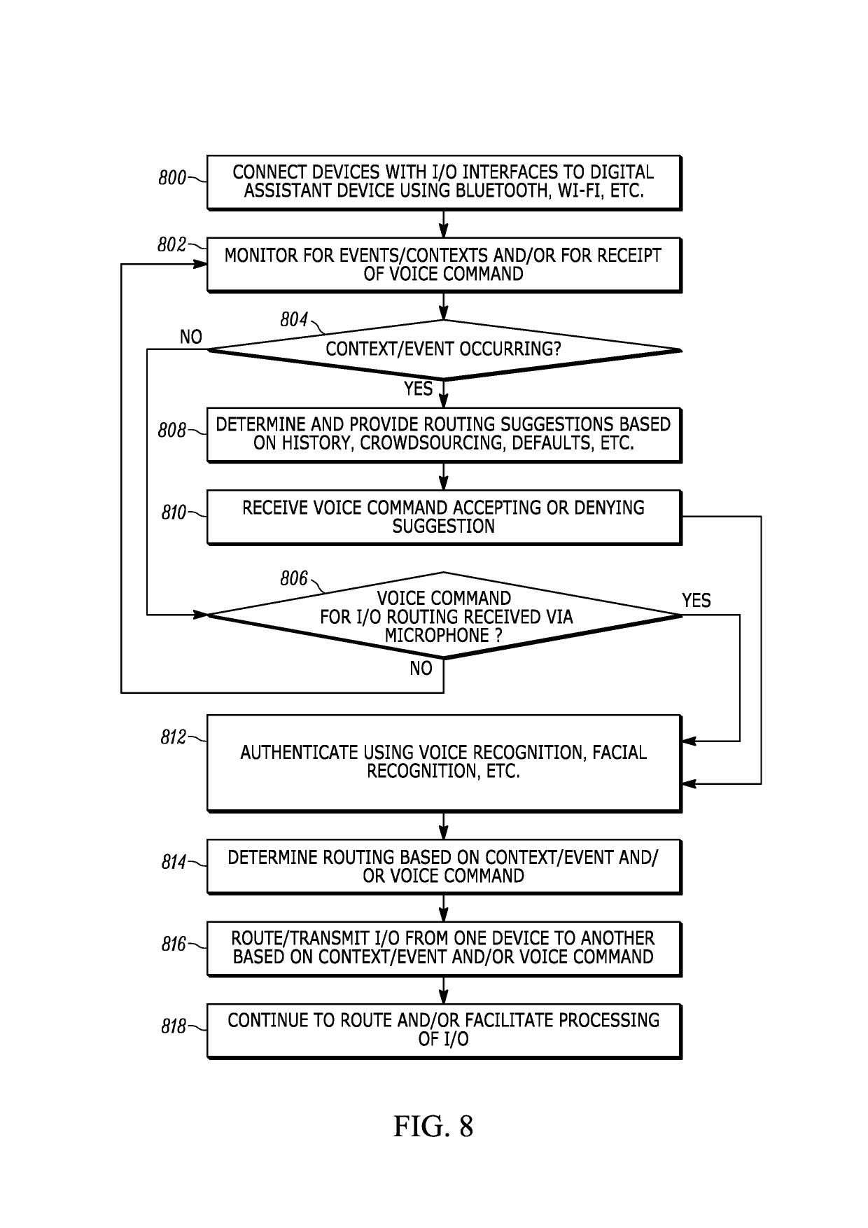

Before moving on to the description of FIG. 8, it is to also be understood in reference to FIGS. 6 and 7 that should a user respond in the negative to the output 602 and/or prompt 704 (e.g., respond to not use the speaker 401), the device 318 may instead simply notify the user 302 of the incoming video call via the phone 402 and await input to the phone 402 by the user 302 to answer the call. Once answered, audio input for the call may be received and video output for the call may be presented using only the phone 402.

Now referring to FIG. 8, it shows example logic that may be executed by a device such as the system 100, device 318, and/or digital assistant in accordance with present principles. Beginning at block 800, the device may connect may connect to or otherwise communicate with devices having I/O interfaces such as displays, keyboards, mice or other cursor-movement devices, printers, and/or speakers. The connection/communication may be over Bluetooth, Wi-Fi, another LAN, an Internet of Things network, or any other suitable communication protocol in accordance with present principles. Also, note that the connection/communication may have been previously established based on a user connecting each respective device to the network (Internet of Things network, Bluetooth network, Wi-Fi network, etc.) and/or by an authorized user verbally specifying that a given I/O interface or device be allowed for I/O routing within the network.

From block 800 the logic may move to block 802. At block 802 the device may monitor for events or contexts that might occur, and/or the device may monitor for a voice command provided by a user. For the voice command, the device may monitor for one by keeping its microphone activated and listening for a response cue using a digital signal processor (DSP) to process input from the microphone and recognize the response cue. For the events/contexts, the device may monitor for one by continually or periodically making determinations regarding the current time of day, what the user is doing to suggest certain inputs or outputs (based on images from a camera or based on microphone input), technological events that may transpire like receipt of a telephone call, what devices are currently powered on and/or in use by the user, etc. E.g., the device may determine that every time (or that a threshold number of times) that X happens, input is routed from I/O interface Y to another device. For example, the user may ask “what's the weather”, and based on the user previously requesting (at least a threshold number of times) that a weather report be presented on the user's TV, the digital assistant may suggest “Would you like me to show you the weather on the TV?”

From block 802 the logic may then proceed to decision diamond 804. At diamond 804 the device, based on the monitoring performed at block 802, may determine whether a context/event for which it has been configured to recognize is occurring. The device may have been configured in such a manner by default by a manufacturer of the device, and/or the device may dynamically determine whether a certain context/event is occurring based on crowdsourced data, history data for the user, history data for the device, etc. that indicates particular events/contexts for which to recognize.

A negative determination at diamond 804 may cause the logic to proceed to decision diamond 806, which will be described shortly. However, first note that an affirmative determination at diamond 804 may instead cause the logic to move to block 808. At block 808 the device may determine and provide I/O routing suggestions to a user based on provider or manufacturer-defined defaults for routing suggestions, crowdsourced data, histories, etc. The suggestion may be provided audibly and/or on a display. Examples of routing suggestions include the audio output 602 and prompt 704 that suggest routing of I/O between the devices 306, 318, 401, and/or 402.

From block 808 the logic may proceed to block 810. At block 810 the device may receive a voice command via a microphone, with the voice command accepting or denying the suggestion provided at block 808. The device may also receive acceptance or denial of the suggestion from the user based on receipt of input to a UI such as the UI 700 described above and/or based on receipt of a gesture from the user that is recognized by the device as an accepting or denial of the suggestion. Gestures may be head nods as disclosed above, or may be other gestures such as a thumbs up hand gesture (accepting) or a thumbs down hand gesture (denying). From block 810 the logic may proceed to block 812, which will be described shortly.

Referring back to the aforementioned diamond 806, at diamond 806 the logic may determine whether a voice command has been received from a user for routing of I/O from one device to another, such as the sending of keyboard input from a laptop to a TV in the example discussed above in reference to FIG. 3. A negative determination at diamond 806 may cause the logic to revert back to block 802 and proceed therefrom. However, responsive to an affirmative determination at diamond 806 the logic may instead proceed to block 812.

At block 812 the device may authenticate the user. For example, the device may execute voice recognition on the voice command it received (for routing I/O or accepting the device's suggestion) to thus determine that the user is authorized to provide such input. As another example, the device may execute facial recognition on images of the user received from a camera to determine that the user is authorized to provide such input. Still other forms of authentication may be used, such as fingerprint or other biometric authentication, receipt of a typewritten or voice password, etc. Authorized users may be established during a setup process for authentication.

From block 812 the logic may then proceed to block 814. At block 814 the device may determine a particular routing of I/O based on the context/event (e.g. a default routing), and/or based on the voice command indicating an I/O routing or accepting the device's suggestion. Thus, the routing may be determined based on the user specifying the desired routing, based on crowdsourced data indicating a most-likely-to-be-preferred routing given the identified context and most-used routing indicated in the crowdsourced data, based on a history indicating a most-likely-to-be-preferred routing given the identified context and most-used routing indicated in the history, etc. Additionally or alternatively, a predictive connection list may be used in some embodiments. For example, recognition/determination of an appropriate routing may be biased towards making a most-likely-to-be-used connection as predicted based on a priority set forth in the list.

After block 814 the logic may then proceed to block 816. At block 816 the device, based on the determination performed at block 814, may communicate with other devices using Wi-Fi, Bluetooth, or another communication protocol to route or otherwise transmit I/O between the other devices and/or through the device executing the logic of FIG. 8. From block 816 the logic may then proceed to block 818 where the device may continue to route I/O and/or otherwise facilitate processing of I/O between devices as needed (e.g., as a telephone call is ongoing).

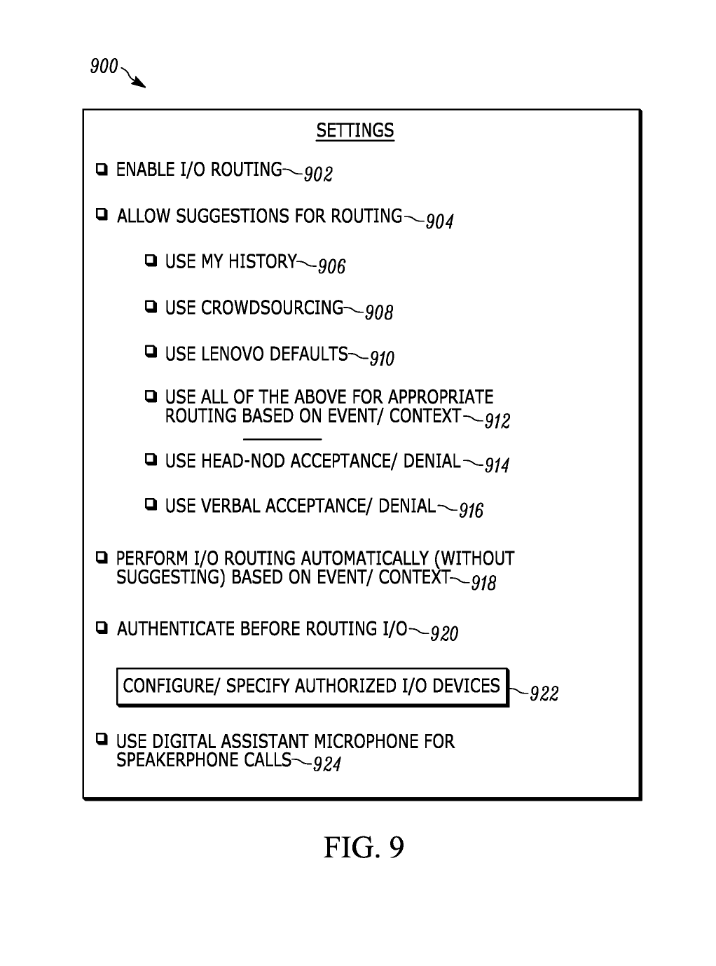

Now in reference to FIG. 9, an example user interface (UI) 900 is shown that may be presented on a display of a device accessible to a digital assistant-enabled device for configuring settings of the digital assistant in accordance with present principles. For example, the UI 900 may be output on a display by the device 318 or system 100 described above. It is to be understood that each of the options and sub-options of the UI 900 that will be discussed below may be selectable by directing input (e.g., touch input) to the respective check box or radio button shown adjacent to each one.

As shown in FIG. 9, the UI 900 may include a first option 902 that is selectable to enable I/O routing in accordance with present principles. For example, the option 902 may be selected to enable the device/digital assistant to execute the logic discussed above in reference to FIG. 8 and/or to undertake the principles set forth above in reference to FIGS. 3-6.

The UI 900 may also include a second option 904 that is selectable to configure the device/digital assistant specifically to provide routing suggestions as disclosed herein, such as to configure the device to provide suggestions as disclosed in reference to block 808 of FIG. 8 above. In some examples, the option 904 may even be accompanied by sub-options 906, 908, 910, and 912 that are respectively selectable to configure the device/digital assistant to use a user/device history for suggestions, to use crowdsourcing data for suggestions, to use digital assistant provider/manufacturer defaults for suggestions, and to use all of the foregoing when evaluating whether a given event or context is occurring as disclosed herein. Additionally, sub-options 914 and 916 may be presented that are respectively selectable to configure the device/digital assistant to use gesture recognition and/or head gestures for acceptance and denial of suggestions, and to use voice recognition and/or verbal input for acceptance and denial of suggestions.

Still further, the UI 900 may include an option 918 that is selectable configure the device/digital assistant to perform I/O routing automatically, e.g., without providing suggestions first that would then be approved by the user prior to routing per user approval. An option 920 may also be presented that is selectable to configure the device/digital assistant to authenticate that a given user is an authorized user of the device/digital assistant prior to I/O routing based on commands from the user. The authentication may be voice and/or facial authentication, as disclosed herein.

FIG. 9 also shows that the UI 900 may include a selector 922 that is selectable to present another UI on the display at which a user may provide input selecting/authorizing various I/O-enabled devices and specific I/O interfaces for use by the device/digital assistant for I/O routing in accordance with present principles. Last, the example UI 900 shows an option 924 that may be selectable to configure the device/digital assistant to automatically and/or always use a microphone on a stand-alone digital assistant device (e.g., the device 318) for speakerphone calls that might be conducted at the device/digital assistant.

Moving on from FIG. 9, it is to be generally understood in accordance with present principles that user commands as disclosed herein, such as those referenced in the description of diamond 806 and block 810 above, may be input via methods other than voice input. For instance, commands may be input via a keyboard (e.g., a command “send keyboard to TV”). Gesture commands may also be used so that, for instance, a user may indicate that an I/O routing connection is about to be indicated (e.g., verbally), and then the user may gesture by pointing to a first device with a finger and then subsequently pointing to a second device with the finger for I/O to be routed from the first device to the second device (and thus, according to the order of the gestures), as may be recognized using gesture recognition.

Before concluding, it is to be understood that although a software application for undertaking present principles may be vended with a device such as the system 100, present principles apply in instances where such an application is downloaded from a server to a device over a network such as the Internet. Furthermore, present principles apply in instances where such an application is included on a computer readable storage medium that is being vended and/or provided, where the computer readable storage medium is not a transitory, propagating signal and/or a signal per se.

It is to be understood that whilst present principals have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged or excluded from other embodiments.

What is claimed is:

1. A first device, comprising:
at least one processor; and
storage accessible to the at least one processor and bearing instructions executable by the at least one processor to:
facilitate a connection between a second device and a third device, at least the second device comprising an input/output (I/O) interface;
receive a voice command from a user to transmit I/O between the second device and the third device;
responsive to receipt of the voice command, transmit I/O between the second device and the third device, the I/O at least one of being input using the I/O interface and being output using the I/O interface.

2. The first device of claim 1, wherein the I/O interface comprises a keyboard, and wherein the instructions are executable by the at least one processor to:
receive a voice command from a user to transmit input from the keyboard to the third device;
responsive to receipt of the voice command to transmit input from the keyboard to the third device, transmit input from the keyboard to the third device.

3. The first device of claim 2, wherein the instructions are executable by the at least one processor to:
facilitate processing, at the third device, of the input from the keyboard.

4. The first device of claim 1, wherein the I/O interface comprises a display, and wherein the instructions are executable by the at least one processor to:
receive a voice command from a user to transmit output from the third device to the second device for presentation of the output using the display;
responsive to receipt of the voice command to transmit output from the third device to the second device for presentation of the output using the display, transmit output from the third device to the second device.

5. The first device of claim 1, comprising a microphone accessible to the at least one processor, wherein the voice command is received via the microphone.

6. The first device of claim 1, wherein the first device is one of: the second device, the third device.

7. The first device of claim 1, wherein the first device is a stand-alone digital assistant device that facilitates communication between the second device and the third device.

8. The first device of claim 1, wherein the instructions are executable by the at least one processor to:
suggest a routing of I/O from one of the second device and the third device to the other of the second device and the third device.

9. The first device of claim 8, wherein the suggestion is made based at least in part on crowdsourced data.

10. The first device of claim 8, wherein the suggestion is made based at least in part on at least one of: an event identified by the first device, a context identified by the first device.

11. The first device of claim 8, wherein the suggestion is made based at least in part on a history accessible to the first device, the history associated with at least one of: the user, the second device, the third device.

12. The first device of claim 8, wherein the instructions are executable by the at least one processor to:
receive user input accepting the suggestion, the user input comprising one or more of a head nod and a verbal acceptance.

13. The first device of claim 1, wherein the instructions are executable by the at least one processor to:
transmit I/O between the second device and the third device responsive to successful voice identification, the voice command being used for the voice identification.

14. The first device of claim 1, wherein the connection is one of: a Wi-Fi connection, a Bluetooth connection.

15. A method, comprising:
identifying a context associated with at least one of the first device and the second device, the first device comprising an input/output (I/O) interface;
suggesting, based on the context, that I/O be performed at one of the first device and the second device using communication with the other of the first device and the second device;
receiving voice input accepting the suggestion; and
transmitting, responsive to receipt of the voice input, I/O between the first device and the second device, the I/O at least one of being input using the I/O interface and being output using the I/O interface.

16. The method of claim 15, wherein the suggesting is performed based at least in part on the context corresponding to data in a history, the history comprising crowdsourced information pertaining to past events.

17. The method of claim 15, wherein the suggesting is performed based at least in part on the context corresponding to data pertaining to defaults set by a digital assistant provider.

18. The method of claim 15, comprising:
authenticating that the voice input is from an authorized user; and
transmitting I/O between the first device and the second device responsive to receipt of the voice input and responsive to the authenticating.

19. A computer readable storage medium (CRSM) that is not a transitory signal, the computer readable storage medium comprising instructions executable by at least one processor to:
process, using a digital assistant, a command to transmit input/output (I/O) between a first device and a second device;
responsive to receipt of the command, transmit I/O between the first device and the second device, the I/O at least one of being input using an I/O interface on the first device and being output using an I/O interface on the second device.

20. The CRSM of claim 19, wherein the instructions are executable by the at least one processor to:
audibly suggest a routing of I/O from one of the first device and the second device to the other of the first device and the second device.

21. The CRSM of claim 19, wherein the command is a voice command.
